(19) United States
(12) Patent Application Publication
(10) Pub. No.: US 2009/0210266 A1
(43) Pub. Date: Aug. 20, 2009

(54) METHODS, SYSTEMS AND COMPUTER PROGRAM PRODUCTS FOR A DECISION FRAMEWORK FOR VALUATING BUSINESS TRANSFORMATION ALTERNATIVES

(75) Inventors: Rama Kalyani Akkiraju, San Jose, CA (US); Richard T. Goodwin, Dobbs Ferry, NY (US); Nitinchandra R. Nayak, Ossining, NY (US); Ning Su, Shanghai (CN)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/031,995

(22) Filed: Feb. 15, 2008

(51) Int. Cl. G06Q 10/00

(52) U.S. Cl. 705/7

(57) ABSTRACT

Methods, systems and computer program products for a decision framework for valuating business transformation alternatives. An exemplary embodiment includes a method for framework for valuating business transformation alternatives, the method including identifying a transformation alternative, performing a strategic value analysis, performing a value risk analysis and performing a qualitative assessment to compute a value of the business transformation alternative based on the strategic value analysis and the value risk analysis.

### BACKGROUND OF THE INVENTION

This invention relates generally to decision frameworks, and more particularly to methods, systems and computer program products for a decision framework for valuating business transformation alternatives.

Companies that grow through mergers and acquisitions are often faced with the challenge of dealing with duplicate and disparate business functions such as human resource and financial management. To address this issue, the ‘shared services’ approach, that is, establishing a centralized workforce to perform business functions for multiple units, has emerged as an important and innovative management tool for improving a firm's business. To achieve shared services, firms may need to transform their business through simplification, standardization, consolidation, in-sourcing, and outsourcing. In deciding whether and how to transform towards shared services, firms need to estimate the value of each of these options. Conventional valuation approaches such as discounted cash flow (DCF) tend to focus on foreseeable cash flows primarily from cost savings and cannot adequately capture other aspects such as managerial flexibility that may be embedded in certain types of transformations. For example, a company may be able to standardize its procure-to-pay business process first and then decide whether or not to consolidate it at a later time instead of consolidating its procure-to-pay function right away across all geographies. This ability to postpone decision making offers not only managerial flexibility in decision making but also helps deal with risks in transformations better.

### BRIEF SUMMARY OF THE INVENTION

An exemplary embodiment includes a method for framework for valuating business transformation alternatives, the method including identifying a transformation alternative, performing a strategic value analysis, performing a value risk analysis and performing a qualitative assessment to compute a value of the business transformation alternative based on the strategic value analysis and the value risk analysis.

Another exemplary embodiment includes a method for framework for valuating business transformation alternatives, the method including identifying a service transformation, performing a strategic value quantification, c, is given by: c=SN(d₁)−Xe^{-rT}N(d₂), where S is a present value of a benefit of the service transformation, N is the standard normal cumulative distribution function, X is an investment required for the service transformation, r is a time value of money, and T is a length of time an investment decision is deferred, and

$${d}_{1} = \frac{ln ( S / X ) + ( r + {σ}^{2} / 2 ) T}{σ \sqrt{T}} and {d}_{2} = {d}_{1} - σ \sqrt{T} ,$$

where σ is a riskiness in achieving the net present value of a benefit of the service transformation. Riskiness of the service transformation can be measured in a number of ways including qualitative approaches such as Balanced Score card and Intangible assets monitor.

A further exemplary embodiment includes a method of analyzing and prioritizing implementation choices in a business transformation setting, the method including applying a real options analysis for valuating the implementation choices.

### TECHNICAL EFFECTS

As a result of the summarized invention, technically we have achieved a solution which evaluates the value of a project, taking in-tangible benefits, like business flexibility into account. The systems and methods described herein identify business opportunities for using a staged implementation approach and take a wider range of benefits into account, which provides a better indication of the value of a project.

### BRIEF DESCRIPTION OF THE DRAWINGS

Referring now to the drawings wherein like elements are numbered alike in the several FIGURES:

FIG. 1 illustrates a chart of a shared services matrix in accordance with exemplary embodiments;

FIG. 2 illustrates a flow chart for a method for valuating service transformation in accordance with exemplary embodiments;

FIG. 3 illustrates a flow of potential transformation paths in accordance with exemplary embodiments;

FIG. 4 illustrates a mapping of a future transformation opportunity to a financial option in accordance with exemplary embodiments;

FIG. 5 illustrates a combination of a balanced scorecard model with an intangible assets monitor resulting in a balanced scorecard model in accordance with exemplary embodiments;

FIG. 6 illustrates a chart of a framework for analyzing value and risk in service transformation in accordance with exemplary embodiments;

FIG. 7 illustrates an example of two approaches for transformation alternatives in accordance with exemplary embodiments;

FIG. 8 illustrates an example of a strategic value quantification mapping in accordance with exemplary embodiments;

FIG. 9 illustrates an example of a table of input of discounted cash flow in one approach from FIG. 7 in accordance with exemplary embodiments;

FIG. 10 illustrates an example of a chart illustrating sensitivity of net present value on different future transformation riskiness in accordance with exemplary embodiments; and

FIG. 11 illustrates a system for a decision framework for valuating business transformation alternatives.

### DETAILED DESCRIPTION OF EXEMPLARY EMBODIMENTS

In exemplary embodiments, the systems and methods described herein provide a decision framework for identifying and quantifying the value of different business transformation alternatives. Exemplary embodiments include systems and methods for identifying potential transformation alternatives and paths. Exemplary embodiments further include enhanced valuation systems and methods for considering intangible value drivers such as managerial flexibility. Further exemplary embodiments include systems and methods for estimating flexibility.

For illustrative purposes “shared services” is used as an example herein. However, it is appreciated that other business transformation alternatives are contemplated in exemplary embodiments. “Shared services” refers to an organization model in which a firm merges separate business functions performed by different units into a distinct unit. This “shared services” unit is viewed as a market vendor, while other units of the firm are seen as its clients. The business functions that may be shared across units include both front-office activity, such as customer service, and back-office work, such as financial management, human resources, and information systems. The types of activities preformed by shared services centers span from transaction-based, that is, routine, high-volume activities, to transformation-based, that is, activities that require extensive expertise, coordination, or are critical to the competitiveness of a certain business unit or the entire firm. Shared services centers devoted to transaction-based activities are usually termed “service centers”, while those focusing on transformation-based activities are often called “centers of excellence”.

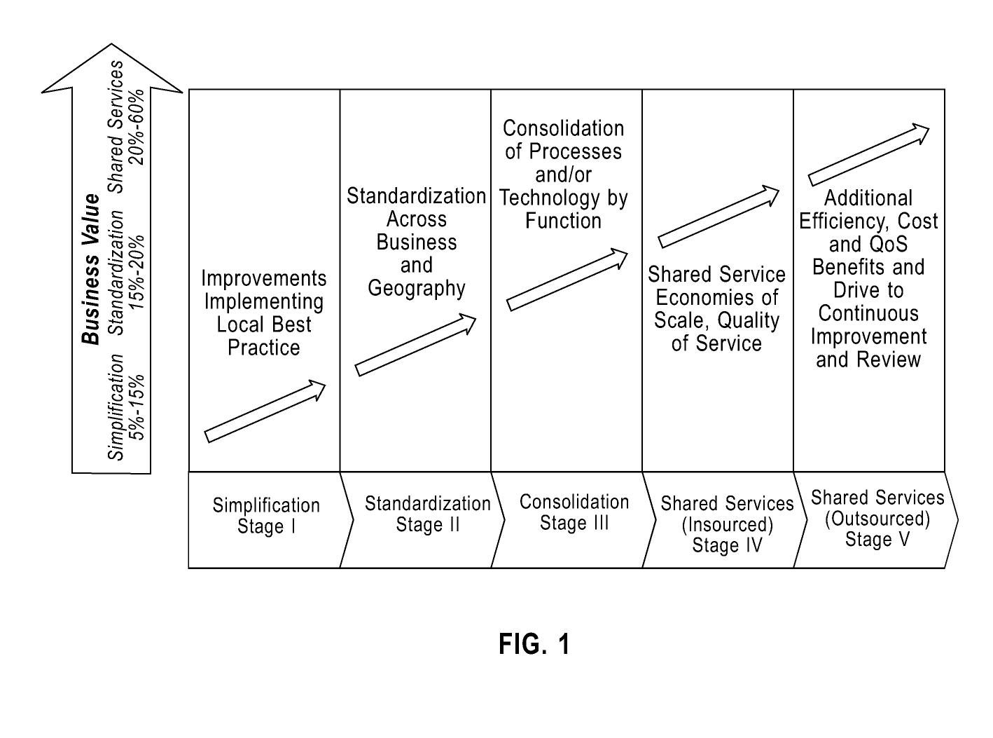

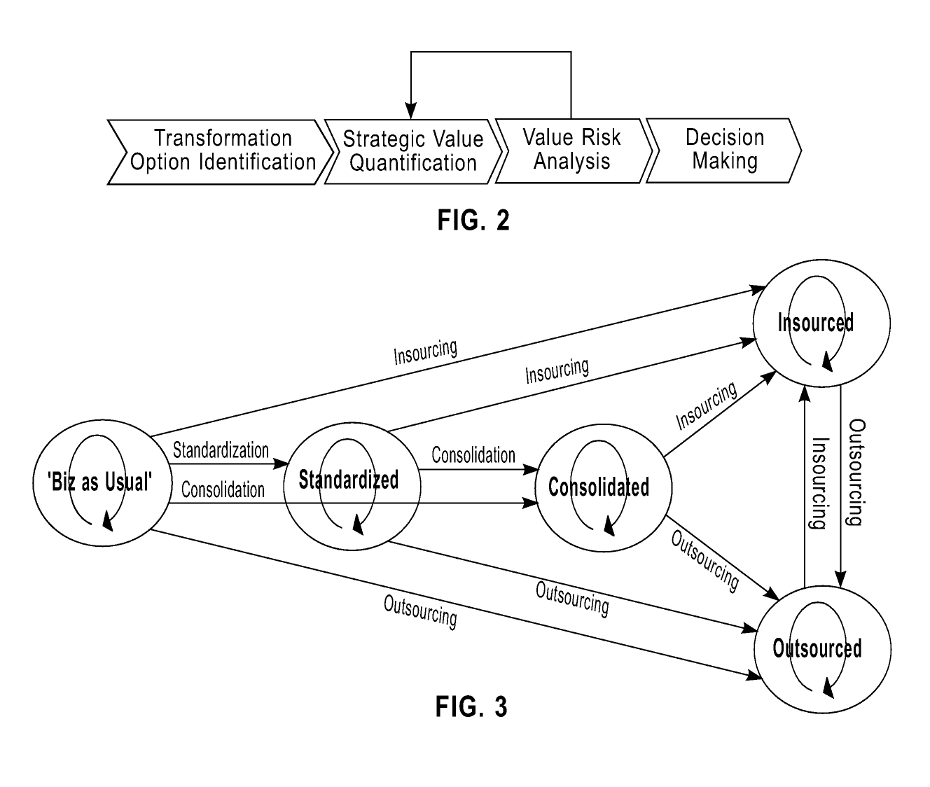

A traditional approach for achieving shared services is that firms may need to go through five transformation stages, namely, Stage 1, simplification, that is, unsystematically improving local practices; Stage 2, standardization, that is, standardizing processes and technology across business and geography; Stage 3, consolidation, that is, consolidating processes and technology by function on shared hardware and software platforms; Stage 4, in-sourcing, that is, setting up an internal organization to provide service to various business units with the firm and possibly to external clients; Stage 5, outsourcing, that is, transferring service to an external service provider. Through in-sourcing or outsourcing, firms can achieve shared services and reap 20-60% business value, as shown in FIG. 1. This traditional approach does not consider the possibility that stages do not have to be followed sequentially to achieve an end state.

A traditional approach for valuating a proposed project is discounted cash flow (DCF). According to this approach, the firm makes an estimation of the future net cash inflows and outflows, discounts these cash flows by a project-specific, risk-adjusted discount rate, and calculates the net present value (NPV) of the project as the difference between discounted cash inflows and outflows. The uncertainty associated with the project is solely represented by the discount rate. The assumption behind the DCF approach is that once initiated, the project would be pursued till its end as planned. Managerial flexibility, such as expanding the project under favorable business condition or abandoning the project under unfavorable condition, is not taken into account in this approach.

A real-option based approach incorporates such managerial flexibility into valuation. This approach builds on the mapping between a project and a certain type of financial option. Specifically, in conducting a project, a firm may have the option but not the obligation to make a specific investment some time in the future to exploit a specific new project opportunity if the future business condition turns out favorable. This is analogous to an investor paying a premium to acquire a European call option which gives the investor the right but not the obligation to buy a certain amount of stock at a given “exercise price” after a given “time to expiration”. According to this mapping, the value of managerial flexibility corresponds to the price of the European call option. The price of the option can be calculated by the Black-Scholes formula. Using the formula, the monetary value of managerial flexibility in a project can be calculated. This value should be added to the original NPV to help firms decide whether to pursue a certain project.

The real-option approach may provide a tool for quantifying the intangible value of strategic flexibility embedded in different transformation approaches. In order to apply this approach, a mapping between a financial option and a service transformation initiative is established.

A balanced scorecard is a methodology for mapping and monitoring the overall functioning of organizations. By supplementing traditional financial measurements with three additional perspectives—internal business processes, customers, and learning and growth—balanced scorecard offers a comprehensive view of an organization's performance, and can therefore be used as a strategic management tool to translate a company's vision and strategy into specific measurements. Balanced scorecard has been adapted in various forms to assist in managing business entities and activities of different nature, from the company as a whole to a specific function, division, or project.

The four perspectives of balanced scorecard, which are, financial, internal business process, customer, and learning and growth, if properly adapted, can provide an overarching conceptual framework for capturing the variety of value that can be delivered by service transformation. Balanced scorecard is also useful for understanding the range of risks associated with service transformation. Such risks also play a critical role in valuating different service transformation approaches.

In exemplary embodiments, systems and methods for valuating different service transformation approaches can include four steps: transformation alternative identification, value risk analysis, strategic value quantification, and decision-making.

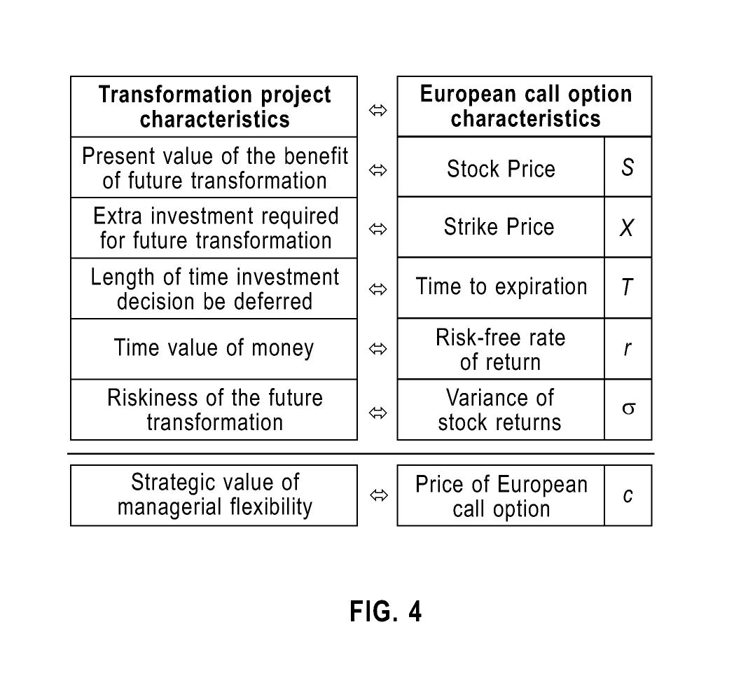

In exemplary embodiments, Transformation Alternative Identification identifies the potential paths of transforming a firm's services. Common steps of service transformation are outlined in FIG. 3, which illustrates that there are multiple ways to achieve a certain stage. For example, a firm may choose to in-source a certain service from the beginning; alternatively, the firm may first standardize the service across the company and then in-source. In exemplary embodiments, the five service states, business as usual, standardized, consolidated, in-sourced, and outsourced correspond to the five stages in the shared services maturity matrix as discussed above.

In exemplary embodiments, embedded in each of the five states is the option, but not obligation, to undertake further transformation. For example, embedded in the “standardized” state is the option to in-source the standardized service. This option is valuable because if in the future the business condition is favorable for in-sourcing, the firm can invest in in-sourcing and reap the benefit; however, if the business condition turns out unfavorable for in-sourcing, the firm is not locked into an in-sourced state and can avoid a loss that is very likely to happen.

In exemplary embodiments, having identified the alternative approaches of service transformation, Strategic Value Quantification quantifies the value of each of these approaches. In exemplary embodiments, discounted cash flow is implemented to calculate the NPV of a certain service transformation. Then a future transformation opportunity is mapped to a European call option.

In exemplary embodiments, when undertaking a certain service transformation, a firm may obtain the option to make extra specific investment some time in the future to exploit a new transformation opportunity that may bring further benefit to the firm. If the business condition turns out favorable for the success of the future transformation, the firm would “exercise” the option by making the extra investment and undertaking this new transformation; otherwise, the firm would abandon the option by not pursuing further transformation.

Now we can create the mapping between future transformation opportunity and European call option. The specific investment required for future transformation corresponds to the exercise price of a European call option; the present value of the estimated benefit of the future transformation is analogous to the current stock price; the length of time the firm can defer the investment decision corresponds to the option's time to expiration; the uncertainty or riskiness of the future transformation's cash flows is analogous to the variance of returns on the stock; finally, the time value of money for the firm corresponds to the risk-free rate of return.

Having established the above correspondence, we can map the “price” of the option to exploit a future transformation opportunity, or the managerial flexibility associated with postponing investment decision into the future, to the price of the European call option. The above mapping is illustrated in FIG. 4. In exemplary embodiments, by applying the Black-Scholes formula, the monetary value of this managerial flexibility can be calculated. Since the option of future transformation is embedded in the current transformation initiative, the firm does not “pay” any stakeholder for this option. Therefore, the “price” of this option is the extra value of current transformation. This value is added to the original NPV to derive the overall strategic value of current transformation.

In particular, the formula for the price of a European call option is the following:

c=SN(d₁)−Xe^{-rT}N(d₂),

where N is the standard normal cumulative distribution function;

$${d}_{1} = \frac{ln ( S / X ) + ( r + {σ}^{2} / 2 ) T}{σ \sqrt{T}} ;$$

$${d}_{2} = {d}_{1} - σ \sqrt{T} .$$

As described above, exemplary embodiments of the systems and methods have been implemented to calculate the tangible financial value of service transformation using discounted cash flow. The exemplary systems and methods have further quantified the intangible value of the strategic flexibility embedded in service transformation. In exemplary embodiments, other types of values can be measured in additional non-financial terms. In addition, other types of value and risk can be considered when valuating service transformation

In exemplary embodiments, value risk analysis addresses other types of value and risk, which can aid firms in qualitatively analyzing a broad range of value and risk in service transformation. In exemplary embodiments, adapting the balanced scorecard approach, this value risk analysis encompasses a set of tangible and intangible value and risk associated with service transformation from the perspectives of finance, operation, customer, and organization.

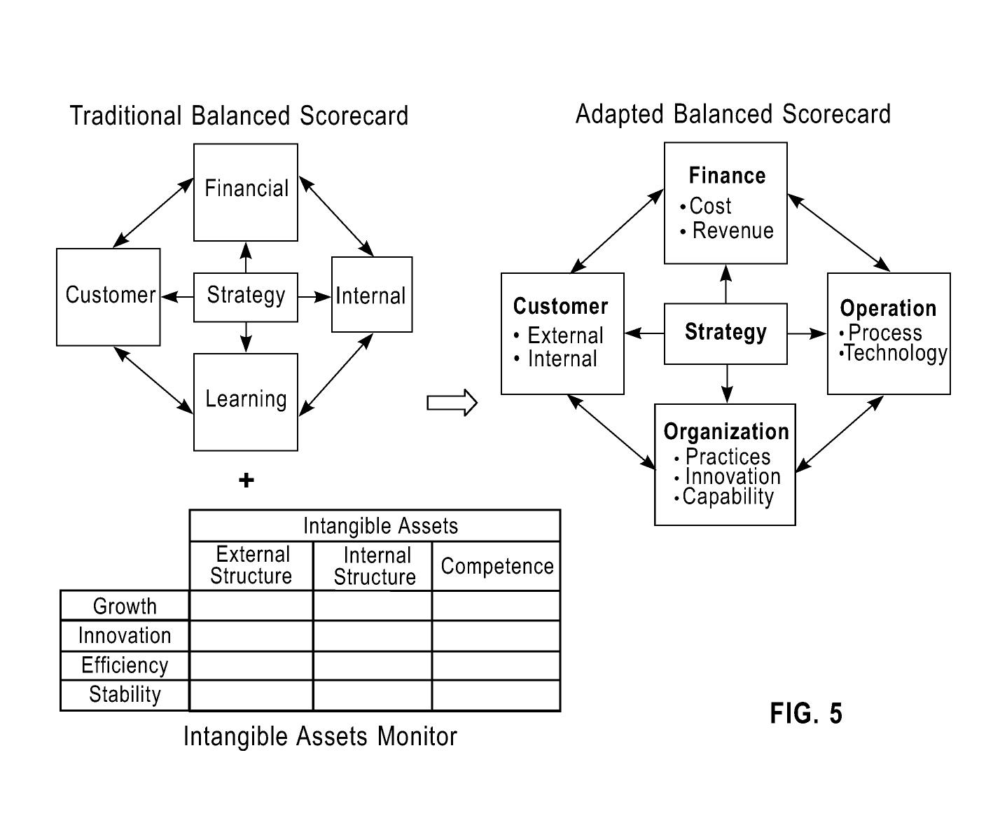

In exemplary embodiments, the basis of value risk analysis is an adapted balanced scorecard. In exemplary embodiments, the original balanced scorecard, which emphasizes the complementarities between financial and non-financial measures of the firm, is combined with “intangible assets monitor”, which focuses on people and knowledge as the foundation of organizations. According to intangible assets monitor, a firm should examine the growth, innovation, efficiency, and stability of its internal structure, external structure, and people competence. In exemplary embodiments, the non-financial perspectives of balanced scorecard are integrated with specific metrics in intangible assets monitor. The result is a balanced scorecard with an enriched set of perspectives from which a firm's capabilities and activities can be comprehensively examined. FIG. 5 illustrates how we adapt the balanced scorecard. In the new balanced scorecard, under each of the four perspectives are the perspective's first-level value and risk drivers.

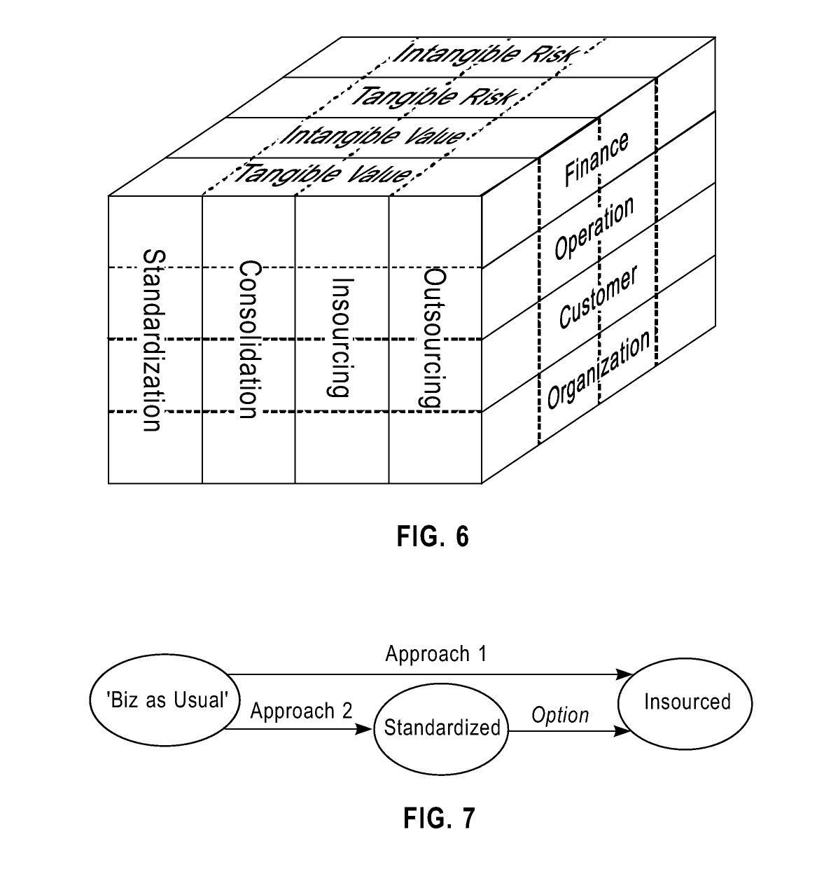

Under each of the four perspectives of the adapted balance scorecard, certain types of value are more “tangible” than others in terms of having a more direct impact on the measurable performance associated with this perspective. For example, high efficiency of a service process directly enhances a company's operational excellence, whereas the alignment of interest of different stakeholders involved in the service process may only contribute to the improvement of the process in the long term. Similarly, certain types of risk are more tangible than others. For example, high employee turnover is considered a more tangible risk because it directly leads to loss of organizational knowledge, whereas a lack of client-oriented culture in an internal service organization tends to harm the performance of the company in a less direct way. In exemplary embodiments, the systems and methods described herein capture both tangible and intangible value and risk in different service transformation approaches. A visual representation of the framework is shown in FIG. 6.

Table 1 outlines value drivers and risk factors associated with service transformation. In exemplary embodiments, firms use these items to qualitatively evaluate the impact of different service transformation. In exemplary embodiments, a distinction between tangible and intangible, value and risk is not strict. As such, the systems and methods described herein take all the factors into consideration. In exemplary embodiments, the various risk factors may assist the firm in estimating the “riskiness of achieving the value of a benefit of the future transformation”, or the σ in Black-Scholes formula. In exemplary embodiments, this number can be estimated based on similar projects in the past.

TABLE 1

| | Value Drivers | | Risk Factors | |
|---|---|---|---|---|
| | Tangible | Intangible | Tangible | Intangible |
| Finance | Cost reduction | Variable cost | Cost fluctuation | Opportunity cost |
| | Revenue increase | structure | Market change | Hidden cost |
| | | Business opportunity | | |
| Operation | Process efficiency | Process flexibility | Complexity | Compliance issues |
| | Technology | Technology renewal | increase | Stakeholder alignment |
| | efficiency | | Coordination | |
| | | | issues | |
| Customer | Customer growth | Customer stability | Demand volatility | Key customer reliance |
| | Customer utilization | Image among | External | Lack of long-term |
| | | customers | competition | client |
| Organization | Employee | Strategic focus | Employee turnover | Loss of innovation |
| | knowledge | Restructuring | Tech | ability |
| | Best practice | facilitation | obsolescence | Cultural difference |

Finally, Decision Making is implemented. As described above, the qualitative value and risk analysis may lead to adjustment or modification of the value of variables in the real option model. Therefore, multiple iterations of Strategic valuation Quantification and Value Risk Analysis may need to be performed to refine the valuation. Finally, decision between alternative transformation approaches should be made based on the quantitative results obtained in Strategic valuation Quantification and the qualitative comparison in Value Risk Analysis.

### EXAMPLE

Firm A is a global leader in information-based solutions. In 2006, the firm decided to transform part of its internal financial management function. An important process of the function is “order to cash”. With the help a leading IT consulting company, Firm identified two most plausible approaches to transforming this process. The first approach involves directly setting up a global service center in an offshore location, and transferring the entire “order-to-cash” process to this center. The second approach involves standardizing the technologies and processes of order-to-cash across the company, letting the company operate this standardized process, and then deciding whether to set up the global center. The exemplary embodiments of the systems and methods described herein are applied to compare the two methodologies.

Transformation Alternative Identification is first applied. Two approaches are visualized in FIG. 7. In Approach 2, the option to in-source is embedded in the “standardized” state. If the business condition turns out favorable for in-sourcing, the firm can still invest in setting up an offshore global service center; if the firm finds that the business condition is unfavorable for in-sourcing, the firm can keep operating on a standardized platform without making further investment. However, if the firm adopts Approach 1 and learns that the business condition does not favor in-sourcing, it is likely that the firm will suffer a loss because it is already locked into this position.

Strategic Value Quantification is then applied. The firm first estimates the discretionary investments and a projection of cash flows in the two approaches. The estimation is shown in Table 2 (in million dollars). In both approaches, the five-year risk-free rate of interest is given at 5.5%; the risk-adjusted discount rate is 12%; the cash flow is perpetuity with a 5% growth rate, based on which the terminal value of cash flows can be calculated.

TABLE 2

| Year | | | | | | | | | | |
|---|---|---|---|---|---|---|---|---|---|---|
| 0 | 1 | 2 | 3 | 4 | 5 | 6 | 7 | 8 | 9 | 10 |

Approach 1: In-sourcing

| | | | | | | | | | | | |
|---|---|---|---|---|---|---|---|---|---|---|---|
| Cash flow | $0.0 | $10.0 | $15.0 | $20.0 | $25.0 | $30.0 | $31.5 | $33.1 | $34.7 | $36.5 | $38.3 |
| Terminal value | | | | | | | | | | | $574.3 |
| Investment | ($300.0) | | | | | | | | | | |
| Discount factor (12%) | 1.000 | 0.893 | 0.797 | 0.712 | 0.636 | 0.567 | 0.507 | 0.452 | 0.404 | 0.361 | 0.322 |
| Net Present Value | $23.4 | | | | | | | | | | |

Approach 2: Standardization First
Phase I: Standardization

| | | | | | | | | | | | |
|---|---|---|---|---|---|---|---|---|---|---|---|
| Cash flow | $0.0 | $2.0 | $4.0 | $6.0 | $8.0 | $10.0 | $10.5 | $11.0 | $11.6 | $12.2 | $12.8 |
| Terminal value | | | | | | | | | | | $191.4 |
| Investment | ($100.0) | | | | | | | | | | |
| Net Present Value | $5.1 | | | | | | | | | | |

Phase II: In-sourcing

| | | | | | | | |
|---|---|---|---|---|---|---|---|
| Cash flow | | $0.0 | $10.0 | $15.0 | $20.0 | $25.0 | $30.0 |
| Terminal value | | | | | | | $450.0 |
| Investment | | ($300.0) | | | | | |
| Net Present Value | ($46.0) | | | | | | |

In Approach 1, the firm makes a discretionary investment of $300.0 million in in-sourcing in year 0. The transformation to the in-sourced state lasts 5 years and completes in year 5, when the annual benefit from in-sourcing reaches $30.0 million. After year 5, the benefit grows at an annual rate of 5%. The annual discount factor of cash flow is 12%. Using these numbers, the NPV of Approach I is calculated, which is $23.4 million.

In Approach 2, the firm makes an initial investment of $100.0 million in standardization in year 0. The transformation to the standardized state lasts 5 years and completes in year 5, when the annual benefit from standardization reaches $10.0 million. After year 5, the benefit grows at an annual rate of 5%. The annual discount factor of cash flow is 12%. Using these numbers, the NPV of standardization in Approach 2 is calculated, which is $5.4 million.

In year 5 of Approach 2, the firm has the option to pursue further transformation by making a $300.0 million investment in in-sourcing. This transformation completes in year 10, when the annual benefit from in-sourcing reaches $30.0 million. Then the benefit grows at an annual rate of 5%. The annual discount factor of cash flow is 12%. However, the annual discount factor for the $300.0 million investment should be the five-year risk-free rate of interest, that is, 5.5%. The reason is that this spending is not subject to the operating and market risks associated with the cash flow. Using the numbers, the NPV of the in-sourcing phase of Approach 2 is calculated, which is $−46.0 million.

If the firm undertakes both Phases I and II, the total NPV is $5.1+(−$46.0)=$−40.9, which is negative and lower than Approach 1's NPV. Approach 1 seems more valuable.

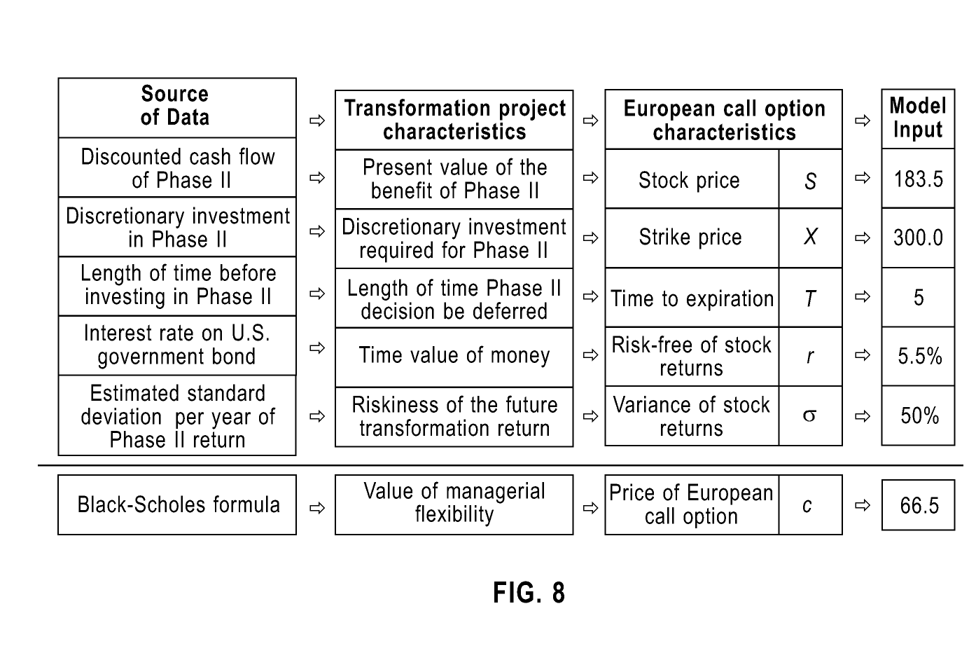

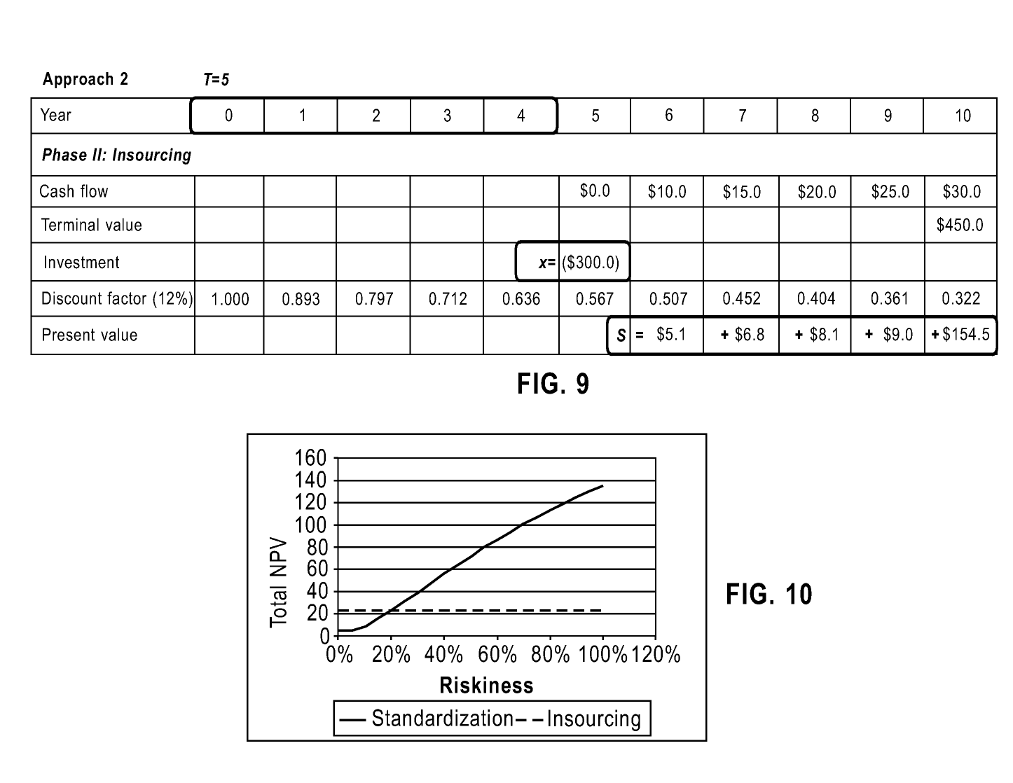

However, the value of managerial flexibility in Approach 2 is not captured. The option of Phase II is mapped to a European call option. The Black-Scholes model is then applied to calculate the value of managerial flexibility. All model inputs can be either obtained from the existing DCF table or estimated. In particular, the present value of Phase II benefit is the sum of the present value of the cash flow of Phase II; discretionary investment for Phase II is $300.0 million; length of time Phase II decision can be deferred is 5 years; time value of money is the five-year risk-free interest rate, 5.5%; riskiness of the future transformation, which is estimated to be 50%, can only be obtained based on past similar projects. Based on these inputs, the Black-Scholes formula shows that the value of managerial flexibility is $66.5. FIG. 8 outlines the mapping. FIG. 9 indicates where the inputs can be obtained in the DCF table of Approach 2.

By adding the value of strategic flexibility to the NPV of the NPV of Phase I of Approach 2, the total value of Approach 2 is obtained, $71.6 million. This value is higher than Approach 1's NPV.

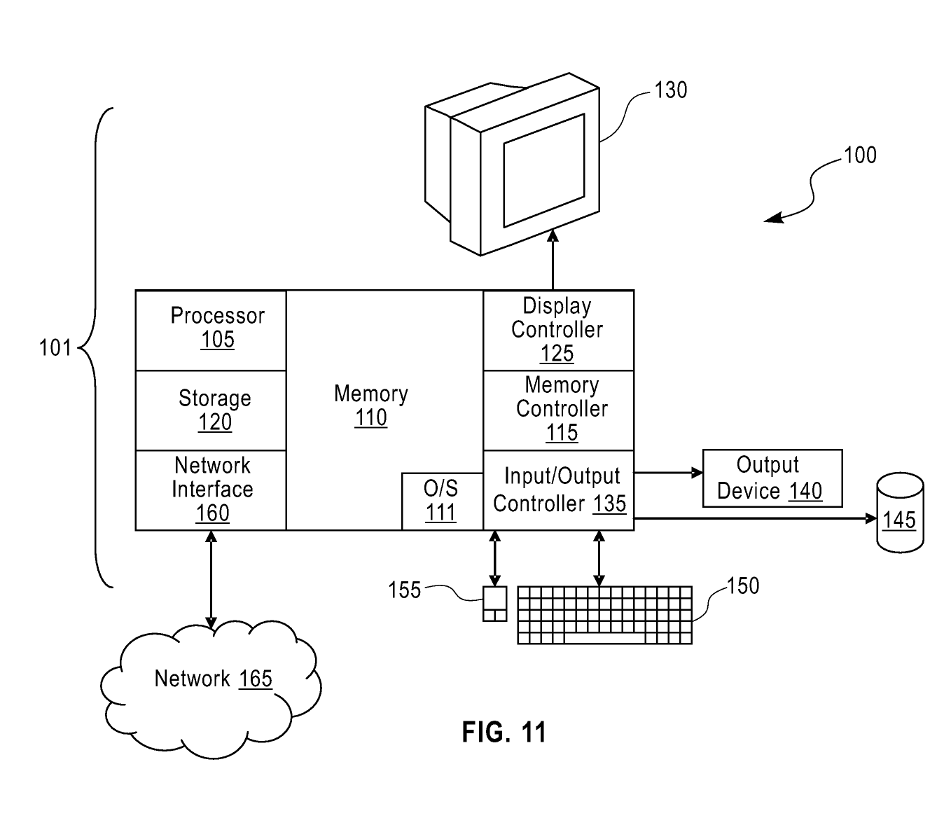

Using the Black-Scholes model, a sensitivity analysis of the value of Approach 2 on the riskiness of future transformation can also be preformed. The result (FIG. 10) suggests that the value of Approach 2 increases with the riskiness of future transformation. If the riskiness is below 20%, Approach 2 has a lower total value than Approach 1.

In the Value Risk Analysis step, the value-risk framework discussed above is implemented to qualitatively compare the two transformation approaches. Although Approach 1 can immediately bring a higher cost saving if the transformation is successful, Approach 2 has a number of advantages. Approach 2 better mitigates financial risk of service transformation through an incremental approach, standardization increases the operational flexibility of the firm's business, the opportunity cost of Approach 2 is lower due to the stepwise investment, and there is more organizational learning opportunity as the firm examines and standardizes its processes.

Decision Making is then considered. A decision is made based on the quantitative and qualitative analysis discussed above. Since Approach 2 has a higher quantitative financial value, and has a number of qualitative advantages over Approach 1, Approach 2 is a more suitable approach for transforming the “order to cash” process at Firm A.

FIG. 11 illustrates a system 100 for a decision framework for valuating business transformation alternatives. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the decision framework methods described herein in accordance with exemplary embodiments and a suitable operating system (OS) 111. The operating system 111 essentially controls the execution of other computer programs, such the decision framework systems and methods described herein, and provides scheduling, input-output control, file and data management, memory management, and communication control and related services.

The decision framework methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the decision framework methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The decision framework methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The decision framework methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the decision framework methods are implemented in hardware, the decision framework methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for framework for valuating business transformation alternatives, the method comprising:
identifying a transformation alternative;
performing a strategic value analysis;
performing a value risk analysis; and
performing a qualitative assessment to compute a value of the business transformation alternative based on the strategic value analysis and the value risk analysis.

2. The method as claimed in claim 1 wherein the transformation alternatives includes at least one of in-sourcing a set of services, outsourcing a set of services, consolidate one or more sets of services, retaining current services and standardizing services.

3. The method as claimed in claim 1 wherein performing a strategic value analysis comprises performing a discounted cash flow analysis on a service identified from the service transformation alternative

4. The method as claimed in claim 3 further comprising creating a mapping between a future transformation opportunity and a European call option.

5. The method as claimed in claim 1 wherein the value of a strategic option, c, is given by:
c=SN(d₁)−Xe^{-rT}N(d₂),
where S is a present value of a benefit of the service transformation, N is the standard normal cumulative distribution function X is an investment required for the service transformation, r is a time value of money, and T is a length of time an investment decision is deferred, and
$${d}_{1} = \frac{ln ( S / X ) + ( r + {σ}^{2} / 2 ) T}{σ \sqrt{T}} and {d}_{2} = {d}_{1} - σ \sqrt{T} ,$$
where σ is a riskiness of the service transformation.

6. The method as claimed in claim 1 wherein performing a value risk analysis comprises developing an adapted balanced scorecard.

7. The method as claimed in claim 6 wherein the adapted balanced scorecard comprises identifying perspectives of value drivers and risk factors.

8. The method as claimed in claim 7 wherein the perspectives of the value drivers and risk factors include at least one of customers, finance, strategy, operation and organization.

9. The method as claimed in claim 8 wherein the value drivers and risk factors drivers include tangible categories and intangible categories.

10. The method as claimed in claim 1 wherein performing a strategic value analysis is quantitative and performing a value risk analysis is qualitative.

11. The method as claimed in claim 10 wherein decision-making comprises performing iterations of the strategic value analysis and the value risk analysis.

12. A method for framework for valuating business transformation alternatives, the method comprising:
identifying a service transformation; and
performing a strategic value quantification, c, is given by:
c=SN(d₁)−Xe^{-rT}N(d₂),
where S is a present value of a benefit of the service transformation, N is the standard normal cumulative distribution function X is an investment required for the service transformation, r is a time value of money, and T is a length of time an investment decision is deferred, and
$${d}_{1} = \frac{ln ( S / X ) + ( r + {σ}^{2} / 2 ) T}{σ \sqrt{T}} and {d}_{2} = {d}_{1} - σ \sqrt{T} ,$$
where σ is a riskiness of the service transformation.

13. A method of analyzing and prioritizing implementation choices in a business transformation setting, the method comprising applying a real options analysis for valuating the implementation choices.

14. The method as claimed in claim 13, wherein the implementation choices comprise choosing business transformation implementation paths from a selection of alternatives.

15. The method as claimed in claim 13, wherein the implementation choices comprise staging points within a business transformation alternative at which a business at least one of expands, abandons, and defers investments for follow-on stages within the business transformation alternative

16. The method as claimed in claim 13, wherein the real options analysis comprises comparing one or more business transformation alternatives having an uncertain value.

17. The method as claimed in claim 13, further comprising:
obtaining a set of transformation alternatives.

18. The method as claimed in claim 13, wherein the business transformation alternatives comprise a staged implementation.

19. The method as claimed in claim 13, wherein the business transformation analysis assesses a value of managerial flexibility associated with ability to postpone investment decisions for follow-on stages within a business transformation alternative.

20. The method as claimed in claim 13, wherein said business transformation analysis includes quantitative values and a qualitative assessment to compute value of business transformation alternative for decision making purposes.
